(19) United States
(12) Patent Application Publication
(10) Pub. No.: US 2005/0025579 A1
(43) Pub. Date: Feb. 3, 2005

(54) Method for forming an underground impermeable wall

(76) Inventors: Kouichi Sogou, Tokyo (JP); Susumu Araki, Tokyo (JP); Koji Sugiyama, Tokyo (JP); Kouichirou Ikeda, Tokyo (JP); Masashi Kamon, Shiga (JP)

Correspondence Address: MCDERMOTT WILL & EMERY LLP, 600 13th Street, N.W., Washington, DC, 20005-3096, US

(21) Appl. No.: 10/860,651

(22) Filed: Jun. 4, 2004

(30) Foreign Application Priority Data
Jun. 6, 2003 (JP) 2003-162874

(51) Int. Cl. E02D 3/12; C09K 17/00

(52) U.S. Cl. 405/267; 405/266

(57) ABSTRACT

An object of the present invention is to provide, without employing cement-based solidifying materials, a method for forming an underground impermeable wall having a strength equivalent to the ground, easily with low cost by retarding the viscosity increase of clay mineral such as bentonite and kibushi clay which is in a powdery or granular state, such that great amount of clay mineral and composite earth are efficiently and homogeneously mixed and agitated while low viscosity is kept. In order to attain the object, clay mineral which is in a powdery or granular state, or the clay mineral and clay mineral suspension is discharged while excavation of the target ground is carried out, and the clay mineral, or the clay mineral and the clay mineral suspension is mixed and agitated with earth and sand of the above described ground.

### TECHNICAL FIELD

The present invention relates to a method for forming an underground impermeable wall employing a clay mineral such as bentonite and kibushi clay.

### BACKGROUND ART

Generally, as a method for forming an impermeable wall or earth retaining wall, a method for forming a wall body in the ground in which excavation of the target ground is carried out by, for example, an earth auger, and at the same time, a cement-based solidifying material, a clay mineral suspension, and earth and sand of the target ground are mixed and agitated so as to solidify, is known. However, when a cement-based solidifying material is incorporated, the wall body is not able to follow the deformation of the ground, and ensuring impermeability over a long period of time is difficult.

On the other hand, in some cases, impermeability of the underground wall is kept over a long period of time by employing a bentonite slurry wall forming method in which an excavation groove is filled with bentonite slurry so as to utilize the followability of bentonite against deformation of the ground which is attributed to self-healing property of the bentonite which is a clay mineral, without employing cement-based solidifying materials. However, since cement-based solidifying materials are not employed, the strength of the wall body is low and collapse or the like of the peripheral ground may be caused.

In view of the foregoing, there has been proposed a method for forming an underground impermeable wall in which powdery bentonite, water, and earth and sand of the target ground are mixed and agitated on site in the ground without employing cement based solidifying materials (for example, see Japanese Patent Application Laid-Open (kokai) No. 1999-43934).

### DISCLOSURE OF THE INVENTION

Problems to be Solved by the Invention

However, great amount of bentonite has to be incorporated to impart, without incorporating cement-based solidifying materials, the ground-equivalent-strength to the underground impermeable wall which is composed of bentonite composite earth. However, there have been problems in terms of techniques and costs that great amount of bentonite cannot be incorporated, since clay mineral suspension has a high viscosity thereby making transportation of the suspension by pump-compression difficult, and agitation efficiency is deteriorated when agitated by a machine such as an earth auger.

Therefore, a main object of the present invention is to provide, without employing cement-based solidifying materials, a method for forming an underground impermeable wall having a strength equivalent to the ground, easily with low cost by retarding the viscosity increase of clay mineral such as bentonite and kibushi clay which is in a powdery or granular state, such that great amount of clay mineral and composite earth are efficiently and homogeneously mixed and agitated while low viscosity is kept.

Means for Solving the Problems

The present invention provides the following in order to solve the above described problems.

<An Invention Described in Claim 1>

An invention described in claim 1 is a method for forming an underground impermeable wall including: a first step of discharging a clay-mineral suspension and mixing and agitating the clay-mineral suspension with earth and sand of the above described ground, during excavation of the target ground; and a second step of transporting by pneumatic compression a clay mineral which is in a powdery or granular state to muddy-water composite earth obtained by mixing and agitating in the first step, and simultaneously mixing and agitating the clay mineral which is in a powdery or granular state with the muddy-water composite earth.

(Working-Effect)

In the first step, a clay-mineral suspension is discharged as a slurry, the clay-mineral suspension is mixed and agitated with earth and sand of the ground, and the target ground is excavated while collapse or the like of the excavation pit or excavation groove is prevented.

In the second step, by transporting the clay mineral which is in a powdery or granular state by pneumatic compression instead of conveying by water, the viscosity of the clay mineral during the conveyance does not increase and the clay mineral is conveyed in the powdery or granular state. Therefore, increase of the viscosity of the clay mineral can be retarded even when the clay mineral is mixed and agitated with muddy-water composite earth, accordingly, the clay mineral can be homogeneously mixed and agitated with the composite earth easily while the viscosity is kept low, and excellent agitation efficiency is exhibited.

That is, the first step and the second step enable efficient and homogeneous mixing and agitating while keeping low viscosity, and after the mixing and agitating, an impermeable wall having strength equivalent to the ground is formed in the ground.

<An Invention Described in Claim 2>

Another invention described in claim 2 is a method for forming an underground impermeable wall as described in claim 1, wherein the amount of the clay mineral in the clay-mineral suspension in the first step is 30 to 500 kg per 1m³ of water, and the amount of the clay mineral which is in a powdery or granular state in the second step is 20 to 450 kg per 1 m³ of the earth and sand to be mixed with.

(Working-Effect)

In the first step, a clay-mineral suspension of comparatively low concentration, i.e., containing 30 to 500 kg of clay mineral per 1 m³ of water, is discharged as a slurry, the clay-mineral suspension is mixed and agitated with earth and sand of the ground, and the target ground is excavated while collapse or the like of the excavation pit or excavation groove is prevented.

In the second step, by transporting 20 to 450 kg of the clay mineral which is in a powdery or granular state per 1 m³ of the earth and sand of the ground to be mixed with, by pneumatic compression instead of conveying by water, the viscosity of the clay mineral does not increase during the conveyance and the clay mineral is conveyed in the powdery or granular state. Therefore, increase of viscosity of the clay mineral can be retarded even when a large amount of the clay mineral, i.e., 20 to 450 kg per 1 m³ of the earth and sand to be mixed with, is mixed and agitated with muddy-water composite earth, accordingly, the clay mineral can be homogeneously mixed and agitated with the composite earth easily while the viscosity is kept low, and excellent agitation efficiency is exhibited.

That is, the first step and the second step enable efficient and homogeneous mixing and agitating while keeping low viscosity, and after the mixing and agitating, an impermeable wall having strength equivalent to the ground is formed in the ground.

<An Invention Described in Claim 3>

Another invention described in claim 3 is a method for forming an underground impermeable wall as described in claim 1 or 2, wherein an excavator equipped with a single or a plurality of excavating shaft(s) is employed, the first step is carried out while excavation is being carried out by the excavating shaft(s), and the second step is carried out while the excavating shaft(s) is being pulled out.

(Working-Effect)

In the first step, a clay-mineral suspension of comparatively low concentration is discharged as a slurry, the clay-mineral suspension is mixed and agitated with earth and sand of the ground, and the target ground is excavated by use of an excavator equipped with a single or a plurality of shaft(s) while collapse or the like of the excavation pit is prevented.

In the second step, by transporting the clay mineral which is in a powdery or granular state by pneumatic compression instead of conveying by water, the viscosity of the clay mineral does not increase during the conveyance and the clay mineral is conveyed in the powdery or granular state. Therefore, increase of viscosity of the clay mineral can be retarded even when the clay mineral is mixed and agitated with muddy-water composite earth, accordingly, the clay mineral can be homogeneously mixed and agitated with the composite earth easily while the viscosity is kept low, and excellent agitation efficiency is exhibited.

In the second step, in order to retard increase of viscosity of the clay mineral, the clay mineral which is in a powdery or granular state is transported by pneumatic compression and discharged into the muddy-water composite earth without being brought into contact with water in advance. If a large amount of the clay mineral is brought into contact with water before being discharged to the muddy-water composite earth, the viscosity increases in the conveying conduit thereby making the compression transport difficult, moreover, homogeneous mixing and agitating after the discharge into the muddy-water composite earth become difficult, and agitation efficiency is deteriorated. When the clay mineral which is in a powdery or granular state is discharged while the excavating shaft(s) is being pulled out such that the excavating shaft(s) is completely pulled out before viscosity increases, homogeneous mixing and agitating can be carried out while low viscosity is kept.

That is, when the clay mineral which is in a powdery or granular state is transported by pneumatic compression into muddy-water composite earth without being brought into contact with water in advance, and water, earth and sand of the ground, the clay mineral suspension, and the clay mineral which is in a powdery or granular state are mixed and agitated before viscosity of the clay mineral increases; homogeneous mixing and agitating can be carried out easily while the muddy-water composite earth keeps low viscosity and excellent agitation efficiency is exhibited, and after the mixing and agitating, an impermeable wall having strength equivalent to the ground is formed in the ground.

<An Invention Described in Claim 4>

Another invention described in claim 4 is a method for forming an underground impermeable wall as described in claim 1 or 2, wherein a chain cutter type excavator which is equipped with a movable base machine and a cutter for groove excavation of the target ground is employed, the first step is carried out while the chain cutter type excavator moves in one direction starting from the setting-in position of the cutter and groove excavation is simultaneously carried out, and the second step is carried out while the chain cutter type excavator returns to the setting-in position of the cutter.

(Working-Effect)

In the first step, a clay-mineral suspension of comparatively low concentration is discharged as a slurry, the clay-mineral suspension is mixed and agitated with earth and sand of the ground, and the target ground is excavated by use of a chain cutter type excavator while collapse or the like of the excavation pit is prevented.

In the second step, by transporting the clay mineral which is in a powdery or granular state by pneumatic compression instead of conveying by water, the viscosity of the clay mineral does not increase during the conveyance and the clay mineral is conveyed in the powdery or granular state. Therefore, increase of viscosity of the clay mineral can be retarded even when the clay mineral is mixed and agitated with muddy-water composite earth, accordingly, the clay mineral can be homogeneously mixed and agitated with the composite earth easily while the viscosity is kept low, and excellent agitation efficiency is exhibited.

In the second step, in order to retard increase of viscosity of the clay mineral, the clay mineral which is in a powdery or granular state is transported by pneumatic compression and discharged into the muddy-water composite earth without being brought into contact with water in advance. If a large amount of the clay mineral is brought into contact with water before being discharged to the muddy-water composite earth, the viscosity increases in the conveying conduit thereby making the compression transport difficult, and homogeneous mixing and agitating after the discharge into the muddy-water composite earth become difficult, and agitation efficiency is deteriorated. When the clay mineral which is in a powdery or granular state is discharged while the chain cutter type excavator returns to the setting-in position of the cutter such that the excavator finishes returning to the setting-in position of the cutter and the cutter is completely pulled out before the viscosity increases, homogeneous mixing and agitating can be carried out while low viscosity is kept.

That is, when the clay mineral which is in a powdery state is transported by pneumatic compression into muddy-water composite earth without being brought into contact with water in advance; and water, earth and sand of the ground, the clay mineral suspension, and the clay mineral which is in a powdery state are mixed and agitated before viscosity of the clay mineral increases; homogeneous mixing and agitating can be carried out easily while viscosity of the muddy-water composite earth is kept low and excellent agitation efficiency is exhibited, and after the mixing and agitating, an underground impermeable wall having strength equivalent to the ground is formed.

<An Invention Described in Claim 5>

Another invention described in claim 5 is a method for forming an underground impermeable wall including: discharging a clay mineral which is in a powdery or granular state, or the clay mineral and a clay mineral suspension, and mixing and agitating the clay mineral, or the clay mineral and the clay mineral suspension with earth and sand of the above described ground, during excavation of the target ground.

(Working-Effect)

To obtain strength equivalent to the ground without employing a cement-based solidifying material, great amount of clay mineral has to be added. In the present invention, the clay mineral is incorporated in two different forms, i.e., in a state of suspension and in a powdery or granular state. By employing two different forms, the clay mineral which is already in a state of suspension (in some cases, incorporated only in a powdery or granular state, or in combination with a state of suspension depending on conditions of the ground) can be discharged in the amount that at least enables prevention of collapse or the like of the excavation pit or the excavation groove, excavation can be carried out while collapse or the like of the excavation pit or the excavation groove is prevented, and after the excavation, additional amount of the clay mineral for obtaining strength which is at least enough to make the wall impermeable in the ground, can be discharged in a powdery or granular state.

In a powdery or granular state, increase of viscosity of the clay mineral due to contact with water or the like, is retarded compare with that in a state of suspension, accordingly, the clay mineral can be easily and homogeneously mixed and agitated with the composite earth while low viscosity is kept, and after the excavation, an underground impermeable wall having strength equivalent to the ground is formed without employing a cement-based solidifying material. In addition, the use of the clay mineral which is in a powdery or granular state reduces the employed amount of water compare with the conventional bentonite slurry wall forming method, thereby leaving little sludge and reducing industrial waste.

<An Invention Described in Claim 6>

Another invention described in claim 6 is a method for forming an underground impermeable wall as described in claim 5, wherein the amount of the clay mineral which is in a powdery or granular state is 20 to 450 kg per 1 m³ of the earth and sand to be mixed with, and the amount of the clay mineral in the clay-mineral suspension is 30 to 500 kg per 1 m³ of water.

(Working-Effect)

In the present invention, the clay mineral is incorporated in two different forms, i.e., in a state of suspension and in a powdery or granular state. By employing two different forms, the clay mineral which is already in a state of suspension (in some cases, incorporated only in a powdery or granular state, or in combination with a state of suspension depending on conditions of the ground) can be discharged in the amount (30 to 500 kg per 1 m³ of water) that at least enables prevention of collapse or the like of the excavation pit or the excavation groove, excavation can be carried out while collapse or the like of the excavation pit or the excavation groove is prevented, and after the excavation, additional amount (20 to 450 kg per 1 m³ of the earth and sand to be mixed with) of the clay mineral for obtaining strength which is at least enough to make the underground wall impermeable, can be discharged in a powdery or granular state.

In a powdery or granular state, increase of viscosity of the clay mineral due to contact with water or the like, is retarded compare with that in a state of suspension, accordingly, the clay mineral is easily and homogeneously mixed and agitated with the composite earth while the viscosity is kept low, and after the excavation, an underground impermeable wall having strength equivalent to the ground is formed without employing a cement-based solidifying material. In addition, the use of the clay mineral which is in a powdery or granular state reduces the employed amount of water compare with the conventional bentonite slurry wall forming method, thereby leaving little sludge and reducing industrial waste.

<An Invention Described in Claim 7>

Another invention described in claim 7 is a method for forming an underground impermeable wall as described in claim 5 or 6, wherein a chain cutter type excavator which is equipped with a movable base machine and a cutter for groove excavation of the target ground is employed, and the chain cutter type excavator moves in one direction starting from the setting-in position of the cutter and groove excavation is simultaneously carried out.

(Working-Effect)

Mixing and agitating are carried out while groove excavation is carried out by use of a chain cutter type excavator. In a powdery or granular state, increase of viscosity of the clay mineral due to contact with water or the like, is retarded compare with that in a state of suspension, accordingly, the clay mineral is easily and homogeneously mixed and agitated with the composite earth while low viscosity is kept, and after the excavation, an impermeable wall having strength equivalent to the ground is formed in the ground without employing a cement-based solidifying material. In addition, the use of the clay mineral which is in a powdery or granular state reduces the employed amount of water compare with the conventional bentonite slurry wall forming method, thereby leaving little sludge and reducing industrial waste.

<An Invention Described in Claim 8>

Another invention described in claim 8 is a method for forming an underground impermeable wall including: a first step of discharging a clay mineral which is in a powdery or granular state, or the clay mineral and a clay mineral suspension, and mixing and agitating the clay mineral, or the clay mineral and the clay mineral suspension with earth and sand of the above described ground, during excavation of the target ground; and a second step of discharging a clay mineral which is in a powdery or granular state to muddy-water composite earth obtained by mixing and agitating in the first step, and mixing and agitating the clay mineral with the muddy-water composite earth.

(Working-Effect)

The first step includes excavation as a principal step, wherein, the clay mineral which is already in a state of suspension (in some cases, incorporated only in a powdery or granular state, or in combination with a state of suspension depending on conditions of the ground) is discharged in the amount that at least enables prevention of collapse or the like of the excavation pit or the excavation groove. The second step includes mixing and agitating as a principal step, wherein, after the excavation, additional amount of the clay mineral for obtaining strength which is at least enough to make the underground wall impermeable, is discharged in a powdery or granular state while mixing and agitating are being carried out.

Therefore, the first step and the second step enable efficient and homogeneous mixing and agitating while keeping low viscosity, and after the mixing and agitating, an underground impermeable wall having strength equivalent to the ground is formed. In addition, the use of the clay mineral which is in a powdery or granular state reduces the employed amount of water compare with the conventional bentonite slurry wall forming method, thereby leaving little sludge and reducing industrial waste.

<An Invention Described in Claim 9>

Another invention described in claim 9 is a method for forming an underground impermeable wall as described in claim 8, wherein, in the first step, the amount of the clay mineral which is in a powdery or granular state is 20 to 450 kg per 1 m³ of the earth and sand to be mixed with, and the amount of the clay mineral in the clay-mineral suspension is 30 to 500 kg per 1 m³ of water; and the amount of the clay mineral which is in a powdery or granular state in the second step is 20 to 450 kg per 1 m³ of the earth and sand to be mixed with.

(Working-Effect)

The first step includes excavation as a principal step, wherein, the clay mineral which is already in a state of suspension (in some cases, incorporated only in a powdery or granular state, or in combination with a state of suspension depending on conditions of the ground) is discharged only in the amount that at least enables prevention of collapse or the like of the excavation pit or the excavation groove, herein, the amount of the clay mineral which is in a powdery or granular sate is 20 to 450 kg per 1 m³ of the earth and sand to be mixed with, and/or the amount of the clay mineral in the clay-mineral suspension is 30 to 500 kg per 1 m³ of water. The second step includes mixing and agitating as a principal step, wherein, after the excavation, additional amount of the clay mineral for obtaining strength which is at least enough to make the underground wall impermeable, is discharged in a powdery or granular state while mixing and agitating are carried out, herein, the amount of the clay mineral which is in a powdery or granular state is 20 to 450 kg per 1 m³ of earth and sand to be mixed with.

Therefore, the first step and the second step enable efficient and homogeneous mixing and agitating while keeping low viscosity, and after the mixing and agitating, an underground impermeable wall having strength equivalent to the ground is formed. In addition, the use of the clay mineral which is in a powdery or granular state reduces the employed amount of water compare with the conventional bentonite slurry wall forming method, thereby leaving little sludge and reducing industrial waste.

<An Invention Described in Claim 10>

Another invention described in claim 10 is a method for forming an underground impermeable wall as described in claim 8 or 9, wherein an excavator equipped with a single or a plurality of excavating shaft(s) is employed, and the first step is carried out while excavation is being carried out by the excavating shaft(s), and the second step is carried out while the excavating shaft(s) is being pulled out.

(Working-Effect)

The first step includes excavation by use of an excavation shaft(s) as a principal step, wherein, the clay mineral which is already in a state of suspension (in some cases, incorporated only in a powdery or granular state, or in combination with a state of suspension depending on conditions of the ground) is discharged only in the amount that at least enables prevention of collapse or the like of the excavation pit or the excavation groove. The second step includes mixing and agitating carried out while the excavation shaft(s) is being pulled out, as a principal step, wherein, after the excavation, additional amount of the clay mineral for obtaining strength which is at least enough to make the underground wall impermeable, is discharged in a powdery or granular state while mixing and agitating are carried out.

Therefore, the first step and the second step enable efficient and homogeneous mixing and agitating while keeping low viscosity, and after the mixing and agitating, an underground impermeable wall having strength equivalent to the ground is formed. In addition, the use of the clay mineral which is in a powdery or granular state reduces the employed amount of water compare with the conventional bentonite slurry wall forming method, thereby leaving little sludge and reducing industrial waste.

<An Invention Described in Claim 11>

Another invention described in claim 11 is a method for forming an underground impermeable wall as described in claim 8 or 9, which employs a chain cutter type excavator equipped with a movable base machine and a cutter for groove excavation of the target ground, wherein the first step is carried out while the chain cutter type excavator moves in one direction from a starting point which is the setting-in position of the cutter and groove excavation is simultaneously carried out; and the second step is carried out while the chain cutter type excavator returns to the setting-in position of the cutter.

(Working-Effect)

The first step includes groove excavation by a chain cutter type excavator as a principal step, wherein, the clay mineral which is already in a state of suspension (in some cases, incorporated only in a powdery or granular state, or in combination with a state of suspension depending on conditions of the ground) is discharged only in the amount that at least enables prevention of collapse or the like of the excavation pit or the excavation groove. The second step includes mixing and agitating carried out while a chain cutter type excavator returns to the setting-in position of the cutter, as a principal step, wherein, after the excavation, additional amount of the clay mineral for obtaining strength which is at least enough to make the underground wall impermeable, is discharged in a powdery or granular state while mixing and agitating are carried out.

Therefore, the first step and the second step enable efficient and homogeneous mixing and agitating while keeping low viscosity, and after the mixing and agitating, an underground impermeable wall having strength equivalent to the ground is formed. In addition, the use of the clay mineral which is in a powdery or granular state reduces the employed amount of water compare with the conventional bentonite slurry wall forming method, thereby leaving little sludge and reducing industrial waste.

<An Invention Described in Claim 12>

Another invention described in claim 12 is a method for forming an underground impermeable wall which employs an excavator equipped with a single or a plurality of excavating shaft(s), the method including: a first step of discharging a clay mineral which is in a powdery or granular state, or the clay mineral and a clay mineral suspension, and mixing and agitating the clay mineral, or the clay mineral and the clay mineral suspension with earth and sand of the above described ground, while excavation is carried out to a predetermined depth by the excavating shaft(s); a second step of carrying out only further mixing and agitating of muddy-water composite earth obtained by mixing and agitating in the first step, while the excavating shaft(s) is being pulled out without discharging the clay mineral suspension and the clay mineral which is in a powdery or granular state; a third step of re-inserting the excavating shaft(s) into the excavation pit which is formed in the first step, and simultaneously discharging the clay mineral which is in a powdery or granular state and mixing and agitating the clay mineral with the muddy-water composite earth; and a fourth step of carrying out only mixing and agitating while the excavating shaft(s) is being pulled out without discharging the clay mineral suspension and the clay mineral which is in a powdery or granular state.

(Working-Effect)

In the second step and the fourth step, only mixing and agitating are carried out without discharging the clay-mineral suspension and the clay mineral which is in a powdery or granular state, therefore, the clay mineral and the muddy-water composite earth are well agitated homogeneously.

<An Invention Described in Claim 13>

Another invention described in claim 13 is a method for forming an underground impermeable wall as described in claim 12, wherein, in the first step, the amount of the clay mineral which is in a powdery or granular state is 20 to 450 kg per 1 m³ of the earth and sand to be mixed with, and the amount of the clay mineral in the clay-mineral suspension is 30 to 500 kg per 1 m³ of water; and the amount of the clay mineral which is in a powdery or granular state in the third step is 20 to 450 kg per 1 m³ of the earth and sand to be mixed with.

(Working-Effect)

The first step includes excavation as a principal step, wherein, the clay mineral which is already in a state of suspension (in some cases, incorporated only in a powdery or granular state, or in combination with a state of suspension depending on conditions of the ground) is discharged only in the amount that at least enables prevention of collapse or the like of the excavation pit or the excavation groove, herein, the amount of the clay mineral which is in a powdery or granular sate is 20 to 450 kg per 1 m³ of the earth and sand to be mixed with, and/or the amount of the clay mineral in the clay-mineral suspension is 30 to 500 kg per 1 m³ of water. The third step includes mixing and agitating as a principal step, wherein, after the excavation, additional amount of the clay mineral for obtaining strength which is at least enough to make the underground wall impermeable, is discharged in a powdery or granular state while mixing and agitating are carried out, herein, the amount of the clay mineral which is in a powdery or granular state is 20 to 450 kg per 1 m³ of earth and sand to be mixed with.

Therefore, the first step and the third step enable efficient and homogeneous mixing and agitating while keeping low viscosity, and after the mixing and agitating, an underground impermeable wall having strength equivalent to the ground is formed. In addition, the use of the clay mineral which is in a powdery or granular state reduces the employed amount of water compare with the conventional bentonite slurry wall forming method, thereby leaving little sludge and reducing industrial waste.

<An Invention Described in Claim 14>

Another invention described in claim 14 is a method for forming an underground impermeable wall which employs a chain cutter type excavator equipped with a movable base machine and a cutter for groove excavation of the target ground, the method including: a first step of discharging a clay mineral which is in a powdery or granular state, or the clay mineral and a clay mineral suspension, and mixing and agitating the clay mineral, or the clay mineral and the clay mineral suspension with earth and sand of the above described ground, while the chain cutter type excavator moves a predetermined length in one direction from a first operation area starting point which is the setting-in position of the cutter to a first operation area finishing point and groove excavation is carried out; a second step of carrying out only further mixing and agitating of muddy-water composite earth obtained by mixing and agitating in the first step, without discharging the clay mineral suspension and the clay mineral which is in a powdery or granular state, while the chain cutter type excavator returns to the first operation area starting point from the first operation area finishing point; a third step of discharging the clay mineral which is in a powdery or granular state, and mixing and agitating the clay mineral with the muddy-water composite earth while the excavator moves again to the first operation area finishing point after the excavator returns to the first operation area starting point, until the excavator reaches the first operation area finishing point, and discharging the clay mineral which is in a powdery or granular state, or the clay mineral and a clay mineral suspension, and mixing and agitating the clay mineral, or the clay mineral and the clay mineral suspension with the earth and sand of the above described ground, while the excavator carries out a predetermined length of groove excavation from a second operation area starting point which is the first operation area finishing point to a second operation area finishing point; and repeating the second step and third step in turn for forming an underground impermeable wall in the all operation area, wherein a finishing point of a preceding operation area serves as a starting point of a following operation area.

(Working-Effect)

In the second step, only mixing and agitating are carried out without discharging the clay-mineral suspension and the clay mineral which is in a powdery or granular state, therefore, the clay mineral and the muddy-water composite earth are well agitated homogeneously.

<An Invention Described in Claim 15>

Another invention described in claim 15 is a method for forming an underground impermeable wall as described in claim 14, wherein, in the first step, the amount of the clay mineral which is in a powdery or granular state is 20 to 450 kg per 1 m³ of the earth and sand to be mixed with, and the amount of the clay mineral in the clay-mineral suspension is 30 to 500 kg per 1 m³ of water; in the third step, between the first operation area starting point to the first operation area finishing point, the amount of the clay mineral which is in a powdery or granular state is 20 to 450 kg per 1 m³ of the earth and sand to be mixed with; and in the third step, between the second operation area starting point to the second operation area finishing point which is disposed a predetermined length away from the second operation area starting point, the amount of the clay mineral which is in a powdery or granular state is 20 to 450 kg per 1 m³ of the earth and sand to be mixed with, and the amount of the clay-mineral in the clay mineral suspension is 30 to 500 kg per 1 m³ of water.

(Working-Effect)

The first step includes excavation as a principal step, wherein, the clay mineral which is already in a state of suspension (in some cases, incorporated only in a powdery or granular state, or in combination with a state of suspension depending on conditions of the ground) is discharged only in the amount that at least enables prevention of collapse or the like of the excavation pit or the excavation groove, herein, the amount of the clay mineral which is in a powdery or granular state is 20 to 450 kg per 1 m³ of the earth and sand to be mixed with, and/or the amount of the clay mineral in the clay-mineral suspension is 30 to 500 kg per 1 m³ of water.

The third step is divided to a stage principally including mixing and agitating, and another stage principally including excavation stage. In a stage which takes place from the first operation area starting point to the first operation area finishing point, after the excavation, additional amount of the clay mineral for obtaining strength which is at least enough to make the underground wall impermeable, is discharged in a powdery or granular state while mixing and agitating are carried out, herein, the amount of the clay mineral which is in a powdery or granular state is 20 to 450 kg per 1 m³ of earth and sand to be mixed with.

In another stage of the third step which takes place from the second operation area starting point to the second operation area finishing point which is a predetermined length away from the starting point, the clay mineral which is already in a state of suspension (in some cases, incorporated only in a powdery or granular state, or in combination with a state of suspension depending on conditions of the ground) is discharged only in the amount that at least enables prevention of collapse or the like of the excavation pit or the excavation groove, herein, the amount of the clay mineral which is in a powdery or granular state is 20 to 450 kg per 1 m³ of the earth and sand to be mixed with, and/or the amount of the clay mineral in the clay-mineral suspension is 30 to 500 kg per 1 m³ of water.

Therefore, the first step and the third step enable efficient and homogeneous mixing and agitating while keeping low viscosity, and after the mixing and agitating, an underground impermeable wall having strength equivalent to the ground is formed. In addition, the use of the clay mineral which is in a powdery or granular state reduces the employed amount of water compare with the conventional bentonite slurry wall forming method, thereby leaving little sludge and reducing industrial waste.

In addition, the method for forming an underground impermeable wall described in any one of the claim 5 to 15, may be arranged such that the clay mineral which is in a powdery or granular state is transported by pneumatic compression.

In this case, by transporting the clay mineral which is in a powdery or granular state by pneumatic compression instead of conveying by water, the viscosity of the clay mineral does not increase during the conveyance and the clay mineral is conveyed in the powdery or granular state, therefore operation efficiency of the conveyance is not deteriorated. In addition, increase of viscosity of the clay mineral can be retarded even when the clay mineral is mixed and agitated with muddy-water composite earth, accordingly, the clay mineral can be easily and homogeneously mixed and agitated with the composite earth while the viscosity is kept low, and excellent agitation efficiency is exhibited.

In addition, the method for forming an underground impermeable wall described in any one of the claim 4, 7, 11, 14 and 15 may be arranged such that the above described mixing and agitating are carried out by an agitation bar attached to the endless chain of the chain cutter type excavator.

In this case, agitation is carried out by the agitation bar attached to the endless chain in the groove which is excavated by the chain cutter type excavator, therefore, the muddy-water composite earth in the groove is homogeneously agitated thoroughly from the bottom to the top.

As described above, according to the present invention, there provided advantages, for example, an underground impermeable wall having a strength equivalent to the ground is formed without employing cement-based solidifying materials, easily with low cost by retarding the viscosity increase of a clay mineral such as bentonite and kibushi clay which is in a powdery or granular state, such that great amount of clay mineral and composite earth are efficiently and homogeneously mixed and agitated while low viscosity is kept.

### BRIEF DESCRIPTION OF THE DRAWINGS

FIG. 1 is a side view of a single-shaft excavator.

FIG. 2 is a front view of a single-shaft excavator.

FIG. 3 is a front view of a distal portion of an excavating shaft.

FIG. 4 shows drawings for explaining a step of excavation, and mixing and agitating.

FIG. 5 is a side view of a tri-shaft excavator.

FIG. 6 is a front view of a distal portion of an excavating shaft of a tri-shaft excavator.

FIG.7 shows a side view and a front view of a chain type excavator.

FIG. 8 shows drawings for explaining a step of excavation, and mixing and agitating by use of a chain type excavator.

FIG. 9 shows explanatory drawings for explaining the seventh embodiment (third pattern).

FIG. 10 shows explanatory drawings for explaining the fifth embodiment (second pattern).

FIG. 11 shows explanatory drawings for explaining the eighth embodiment (fourth pattern).

### BEST MODES FOR CARRYING OUT THE INVENTION

Hereinafter, embodiments of a method for forming an underground impermeable wall according to the present invention will be described.

<The Clay Mineral in Claim 1 to 4>

The clay mineral incorporated in the first step and the second step according to claim 1 to 4 will next be explained.

Conceivable examples of the clay mineral include bentonite and kibushi clay. Also, arbitral amount of coal ash, hydraulic slag, fly ash, and other fine-grained earth or the like may be arbitrarily added to the clay mineral. The term “clay-mineral suspension” in the present invention includes the meaning of “clay-mineral solution”. The term “the amount of earth and sand to be mixed with” means the amount of earth and sand excavated from the target ground (same, hereinafter).

The clay-mineral suspension employed in the first step is a bentonite suspension containing 30 to 250 kg of bentonite per 1 m³ of water (hereinafter, referred to as “suspension A1”), or kibushi clay suspension containing 50 to 500 kg of kibushi clay per 1 m³ of water (hereinafter, referred to as “suspension B1”). These clay-mineral suspensions are employed for preventing collapse or the like of the excavation pit upon excavation by an excavator, and have comparatively low concentration. Therefore, the viscosity thereof is low, and mixing and agitating are carried out efficiently. The suspension A1 preferably contains 30 to 100 kg of bentonite per 1 m³ of water in order to improve agitation efficiency.

The clay mineral which is in a powdery or granular state in the second step is 20 to 300 kg of bentonite which is in a powdery or granular state per 1 m³ of earth and sand to be mixed with (hereinafter, referred to as “powder/granule A1”), or 40 to 450 kg of kibushi clay which is in a powdery or granular state per 1 m³ of earth and sand to be mixed with (hereinafter, referred to as “powder/granule B1”). The clay mineral is incorporated in order to eventually impart strength equivalent to that of the ground to the underground impermeable wall formed in the target ground, i.e.; the clay mineral is transported by pneumatic compression into the muddy-water composite earth which is obtained by mixing and agitating of the clay mineral suspension with the earth and sand of the target ground in the first step, and the clay mineral which is in a powdery or granular state is mixed and agitated with the muddy-water composite earth. The powder/granule A1 preferably contains 50 to 200 kg of bentonite per 1 m³ of earth and sand to be mixed with in order to improve the strength.

In the second step, in order to retard increase of viscosity of the clay mineral, the clay mineral which is in a powdery or granular state is transported by pneumatic compression and discharged into the muddy-water composite earth without being brought into contact with water in advance. If a large amount of the clay mineral is brought into contact with water before being discharged to the muddy-water composite earth, the viscosity increases in the conveying conduit thereby making the compression transport difficult, moreover, homogeneous mixing and agitating after the discharge into the muddy-water composite earth become difficult, and agitation efficiency is deteriorated. Therefore, when the clay mineral which is in a powdery or granular state is transported by pneumatic compression into muddy-water composite earth without being brought into contact with water in advance, and the clay mineral is mixed and agitated with water, earth and sand of the ground, the clay mineral suspension, before viscosity of the clay mineral increases; homogeneous mixing and agitating can be carried out easily while the muddy-water composite earth keeps low viscosity and excellent agitation efficiency is exhibited, and after the mixing and agitating, an underground impermeable wall having strength equivalent to the ground is formed.

Regarding the combination of the clay-mineral suspension and the powder/granule clay mineral in the first step and the second step, for example, when the soil layer or the like contains a large amount of soil having low viscosity or vulnerable sandy soil, and collapse or the like easily happens in the excavation pit formed in the target ground; the combination of the suspension A1 and powder/granule A1 is preferably employed in the first step and the second step.

When the soil layer or the like contains a large amount of soil having high viscosity, or solid sandy soil or gravel, and collapse or the like of the excavation pit does not easily happen; from the viewpoint of operation cost or the like, the combination of the suspension B1 and powder/granule B1 is preferably employed.

From the viewpoint of, for example, the property of the target ground, operation technique, and operation cost, the suspension A1 may be employed in the first step and the powder/granule B1 may be employed in the second step, or conversely, the suspension B1 may be employed in the first step and the powder/granule A1 may be employed in the second step.

The above described embodiment and working-effect regarding the clay mineral in claim 1 to 4 are summarized and described below.

(First Embodiment)

A first embodiment is a method for forming an underground impermeable wall described in claim 1, wherein, the clay-mineral suspension in the first step is a bentonite suspension containing 30 to 250 kg of bentonite per 1 m³ of water, and the clay mineral which is in a powdery or granular state in the second step is 20 to 300 kg of bentonite which is in a powdery or granular state per 1 m³ of earth and sand to be mixed with.

(Working-Effect)

This method is employed at the ground, for example, where the soil layer or the like contains a large amount of soil having low viscosity or vulnerable sandy soil, and collapse or the like of the excavation pit easily occurs.

(Second Embodiment)

A second embodiment is a method for forming an underground impermeable wall described in claim 1, wherein, the clay-mineral suspension in the first step is kibushi clay suspension containing 50 to 500 kg of kibushi clay per 1 m³ of water, and the clay mineral which is in a powdery or granular state in the second step is 40 to 450 kg of kibushi clay which is in a powdery or granular state per 1 m³ of earth and sand to be mixed with.

(Working-Effect)

This method is employed at the ground, for example, where the soil layer or the like contains a large amount of soil having high viscosity, or solid sandy soil or gravel, and collapse or the like of the excavation pit does not easily happen.

(Third Embodiment)

A third embodiment is a method for forming an underground impermeable wall described in claim 1, wherein, the clay-mineral suspension in the first step is a bentonite suspension containing 30 to 250 kg of bentonite per 1 m³ of water, and the clay mineral which is in a powdery or granular state in the second step is 40 to 450 kg of kibushi clay which is in a powdery or granular state per 1 m³ of earth and sand to be mixed with.

(Fourth Embodiment)

A fourth embodiment is a method for forming an underground impermeable wall described in claim 1, wherein, the clay mineral suspension in the first step is kibushi clay suspension containing 50 to 500 kg of kibushi clay per 1 m³ of water, and the clay mineral which is in a powdery or granular state in the second step is 20 to 300 kg of bentonite which is in a powdery or granular state per 1 m³ of earth and sand to be mixed with.

(Working-Effect)

In the first step and the second step of the third embodiment and the fourth embodiment, both bentonite and kibushi clay are employed in a combination of suspension state or, a powdery or granular state; therefore there exhibited effects, for example, in terms of the property of the target ground, operation technique, and operation cost.

<The Clay Mineral in Claim 5 to 15>

The clay mineral incorporated in the steps in claim 5 to 15 will next be described. As described above, conceivable examples of the clay mineral include bentonite and kibushi clay. Also, arbitral amount of coal ash, hydraulic slag, fly ash, and other fine-grained earth or the like may be arbitrarily added to the clay mineral. The term “clay-mineral suspension” in the present invention includes the meaning of “clay-mineral solution”. The function of the clay mineral and the clay-mineral suspension and working-effect in each combination are described above. Therefore, such explanations are omitted and merely the composition of the clay mineral in embodiments according to claim 5 to 15 is described below.

(Fifth Embodiment)

In a method for forming an underground impermeable wall including: discharging a clay mineral which is in a powdery or granular state, or the clay mineral and a clay mineral suspension, and mixing and agitating the clay mineral, or the clay mineral and the clay mineral suspension with earth and sand of the above described ground, during excavation of the target ground; the amount of the clay mineral which is in a powdery or granular state is 20 to 450 kg per 1 m³ of earth and sand to be mixed with, and the amount of the clay mineral in the clay-mineral suspension is 30 to 500 kg per 1 m³ of water.

The clay-mineral suspension is a bentonite suspension containing 30 to 250 kg of bentonite per 1 m³ of water (hereinafter, referred to as “suspension A2”), or kibushi clay suspension containing 50 to 500 kg of kibushi clay per 1 m³ of water (hereinafter, referred to as “suspension B2”). The suspension A2 preferably contains 30 to 100 kg of bentonite per 1 m³ of water in order to improve agitation efficiency. The clay mineral which is in a powdery or granular state is 20 to 300 kg of bentonite which is in a powdery or granular state per 1 m³ of earth and sand to be mixed with (hereinafter, referred to as “powder/granule A2”), or 40 to 450 kg of kibushi clay which is in a powdery or granular state per 1 m³ of earth and sand to be mixed with (hereinafter, referred to as “powder/granule B2”). The powder/granule A2 preferably contains 50 to 200 kg of bentonite per 1 m³ of earth and sand to be mixed with in order to improve the strength. Depends on the conditions of the ground, in some cases, the clay mineral is incorporated only in a powdery or granular state or incorporated in combination with a state of suspension, and these are applied to, for example, the ground exhibiting high percentage of water content.

(Sixth Embodiment)

In a method for forming an underground impermeable wall including: a first step of discharging a clay mineral which is in a powdery or granular state, or the clay mineral and a clay mineral suspension, and mixing and agitating the clay mineral, or the clay mineral and the clay mineral suspension with earth and sand of the above described ground, during excavation of the target ground; and a second step of discharging a clay mineral which is in a powdery or granular state to muddy-water composite earth obtained by mixing and agitating in the first step, and mixing and agitating the clay mineral with the muddy-water composite earth; the amount of the clay mineral which is in a powdery or granular state in the first step is 20 to 450 kg per 1 m³ of earth and sand to be mixed with, the amount of clay mineral in the clay-mineral suspension is 30 to 500 kg per 1 m³ of water, and the amount of the clay mineral which is in a powdery or granular state in the second step is 20 to 450 kg per 1 m³ of earth and sand to be mixed with.

The clay-mineral suspension is a bentonite suspension containing 30 to 250 kg of bentonite per 1 m³ of water (hereinafter, referred to as “suspension A3”), or kibushi clay suspension containing 50 to 500 kg of kibushi clay per 1 m³ of water (hereinafter, referred to as “suspension B3”). The suspension A3 preferably contains 30 to 100 kg of bentonite per 1 m³ of water in order to improve agitation efficiency. The clay mineral which is in a powdery or granular state is 20 to 300 kg of bentonite which is in a powdery or granular state per 1 m³ of earth and sand to be mixed with (hereinafter, referred to as “powder/granule A3”), or 40 to 450 kg of kibushi clay which is in a powdery or granular state per 1 m³ of earth and sand to be mixed with (hereinafter, referred to as “powder/granule B3”). The powder/granule A3 preferably contains 50 to 200 kg of bentonite per 1 m³ of earth and sand to be mixed with in order to improve the strength.

(Seventh Embodiment)

In a method for forming an underground impermeable wall which employs an excavator equipped with a single or a plurality of excavating shaft(s), the method including: a first step of discharging a clay mineral which is in a powdery or granular state, or the clay mineral and a clay mineral suspension, and mixing and agitating the clay mineral, or the clay mineral and the clay mineral suspension with earth and sand of the above described ground, while excavation is carried out to a predetermined depth by the excavating shaft(s); a second step of carrying out only further mixing and agitating of muddy-water composite earth obtained by mixing and agitating in the first step, while the excavating shaft(s) is being pulled out without discharging the clay mineral suspension and the clay mineral which is in a powdery or granular state; a third step of re-inserting the excavating shaft(s) into the excavation pit which is formed in the first step, and simultaneously discharging the clay mineral which is in a powdery or granular state and mixing and agitating the clay mineral with the muddy-water composite earth; and a fourth step of carrying out only mixing and agitating while the excavating shaft(s) is being pulled out without discharging the clay mineral suspension and the clay mineral in a powdery or granular state; the amount of the clay mineral which is in a powdery or granular state in the first step is 20 to 450 kg per 1 m³ of earth and sand to be mixed with, the amount of clay mineral in the clay-mineral suspension is 30 to 500 kg per 1 m³ of water, and the amount of the clay mineral which is in a powdery or granular state in the third step is 20 to 450 kg per 1 m³ of earth and sand to be mixed with.

The clay-mineral suspension is a bentonite suspension containing 30 to 250 kg of bentonite per 1 m³ of water (hereinafter, referred to as “suspension A4”), or kibushi clay suspension containing 50 to 500 kg of kibushi clay per 1 m³ of water (hereinafter, referred to as “suspension B4”). The suspension A4 preferably contains 30 to 100 kg of bentonite per 1 m³ of water in order to improve agitation efficiency. The clay mineral which is in a powdery or granular state is 20 to 300 kg of bentonite which is in a powdery or granular state per 1 m³ of earth and sand to be mixed with (hereinafter, referred to as “powder/granule A4”), or 40 to 450 kg of kibushi clay which is in a powdery or granular state per 1 m³ of earth and sand to be mixed with (hereinafter, referred to as “powder/granule B4”). The powder/granule A4 preferably contains 50 to 200 kg of bentonite per 1 m³ of earth and sand to be mixed with in order to improve the strength.

(Eighth Embodiment)

In a method for forming an underground impermeable wall which employs a chain cutter type excavator equipped with a movable base machine and a cutter for groove excavation of the target ground, the method including: a first step of discharging a clay mineral which is in a powdery or granular state, or the clay mineral and a clay mineral suspension, and mixing and agitating the clay mineral, or the clay mineral and the clay mineral suspension with earth and sand of the above described ground, while the chain cutter type excavator moves a predetermined length in one direction from a first operation area starting point which is the setting-in position of the cutter to a first operation area finishing point while groove excavation is carried out; a second step of carrying out only further mixing and agitating of muddy-water composite earth obtained by mixing and agitating in the first step, without discharging the clay mineral suspension and the clay mineral which is in a powdery or granular state, while the chain cutter type excavator returns to the first operation area starting point from the first operation area finishing point; a third step of discharging the clay mineral which is in a powdery or granular state, and mixing and agitating the clay mineral with the muddy-water composite earth while the excavator moves again to the first operation area finishing point after the excavator returns to the first operation area starting point, until the excavator reaches the first operation area finishing point, and discharging the clay mineral which is in a powdery or granular state, or the clay mineral and a clay mineral suspension, and mixing and agitating the clay mineral, or the clay mineral and the clay mineral suspension with the earth and sand of the above described ground, while the excavator carries out a predetermined length of groove excavation from a second operation area starting point which is the first operation area finishing point to a second operation area finishing point; and repeating the second step and third step in turn for forming an underground impermeable wall in the all operation area, wherein a finishing point of a preceding operation area serves as a starting point of a following operation area; the amount of the clay mineral which is in a powdery or granular state in the first step is 20 to 450 kg per 1 m³ of earth and sand to be mixed with, the amount of clay mineral in the clay-mineral suspension is 30 to 500 kg per 1 m³ of water, and the amount of the clay mineral which is in a powdery or granular state discharged from the first operation area starting point to the first operation area finishing point in the third step is 20 to 450 kg per 1 m³ of earth and sand to be mixed with, the amount of the clay mineral which is in a powdery or granular state discharged from the second operation area starting point to the second operation area finishing point which is a predetermined length away from the starting point in the third step is 20 to 450 kg per 1 m³ of earth and sand to be mixed with, and the amount of clay mineral in the clay-mineral suspension is 30 to 500 kg per 1 m³ of water.

The clay-mineral suspension is a bentonite suspension containing 30 to 250 kg of bentonite per 1 m³ of water (hereinafter, referred to as “suspension A5”), or kibushi clay suspension containing 50 to 500 kg of kibushi clay per 1 m³ of water (hereinafter, referred to as “suspension B5”). The suspension A5 preferably contains 30 to 100 kg of bentonite per 1 m³ of water in order to improve agitation efficiency. The clay mineral which is in a powdery or granular state is 20 to 300 kg of bentonite which is in a powdery or granular state per 1 m³ of earth and sand to be mixed with (hereinafter, referred to as “powder/granule A5”), or 40 to 450 kg of kibushi clay which is in a powdery or granular state per 1 m³ of earth and sand to be mixed with (hereinafter, referred to as “powder/granule B5”). The powder/granule A5 preferably contains 50 to 200 kg of bentonite per 1 m³ of earth and sand to be mixed with in order to improve the strength.

<Application of a Single-shaft Excavator>

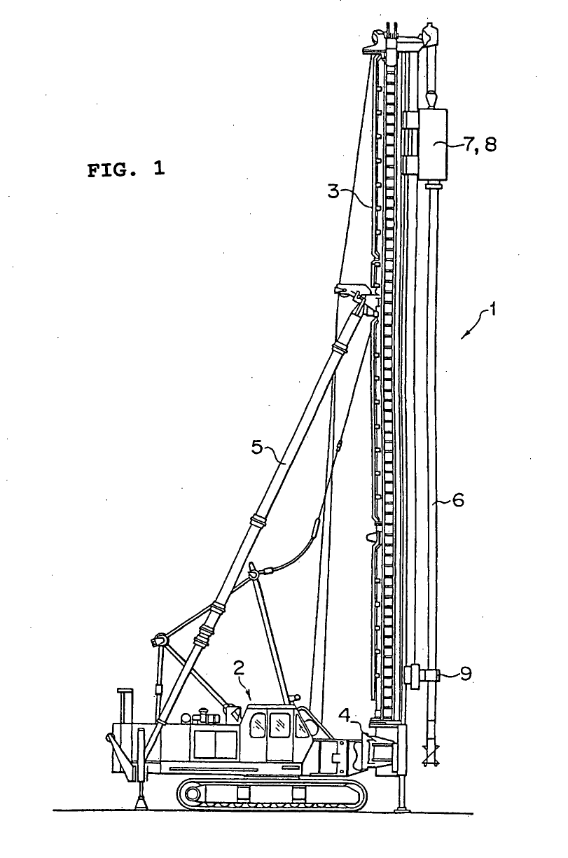

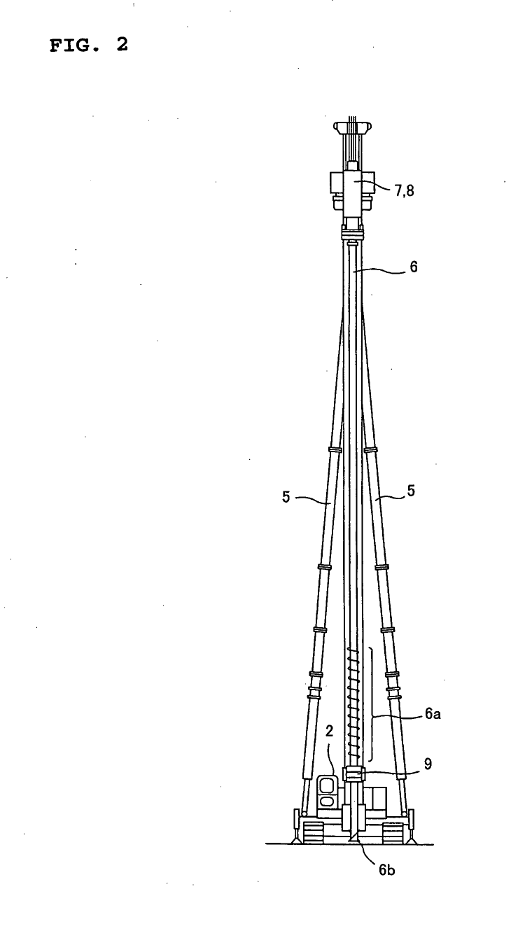

A single-shaft excavator 1 has its entire structure, for example, that shown in FIG. 1 and FIG. 2. That is, in the structure, a leader 3 which is upheld and set at the front of a base machine 2 is supported by a leader receptacle 4 and a backstay 5 of the base machine 2. At the leader 3, a long excavating shaft 6 which is composed of a plurality of excavating shaft units connected in the longitudinal direction, is provided so as to be movable in the vertical direction, and a motive power source 7 which is slidable along the leader 3 is mounted at the head of the excavating shaft 6. The motive power of the motive power source 7 is transmitted to the excavating shaft 6 via a speed reducer 8.

Electric motors are generally employed as the motive power source 7, though oil hydraulic motors are employed in some cases. The number of employed electric motor is not limited to one, and a plurality of motors maybe employed. The motive power produced by the electric motors is integrated to one by unillustrated gear train, the revolution speed is reduced at the speed reducer 8, and the power is transmitted to the excavating shaft 6.

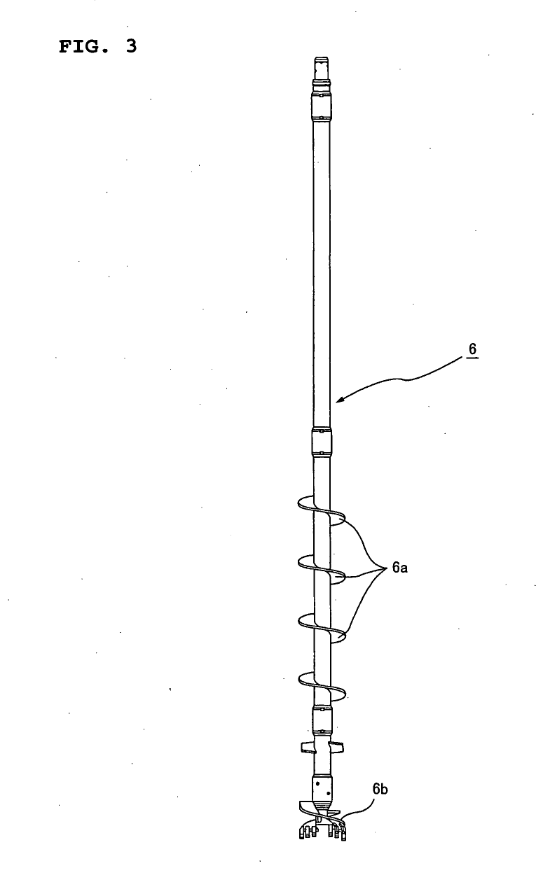

As shown in FIG. 3, the excavating shaft 6 is composed of a plurality of excavating rod units connected in the longitudinal direction, and includes an agitation head 6a at its lower part and excavation head 6b which is attached to its lower end. The agitation head 6a is composed of blade portions or spiral blades. A fluid feeding source (unillustrated) for feeding clay mineral suspension such as suspension A or suspension B is provided at the upper end of the excavating shaft 6, and a fluid channel (unillustrated) for the suspension is formed in the excavating shaft 6 such that the clay mineral suspension can be discharged from the first discharge outlet (unillustrated) at the lower end of the excavating shaft 6.

A conveying conduit (unillustrated) is formed in the excavating shaft 6. A force feeding apparatus (unillustrated) such as compressor for transporting clay mineral such as powder/granule A or powder/granule B by air compression is connected to one end of the conveying conduit (unillustrated) at outside. A second discharge outlet (unillustrated) for discharging the conveyed clay mineral is formed at the lower end of the excavating shaft 6.

A single-shaft excavator of this kind is publicly known, and a method for forming an underground impermeable wall according to the present invention is not limited to the above described single-shaft excavator 1.

(First Pattern)

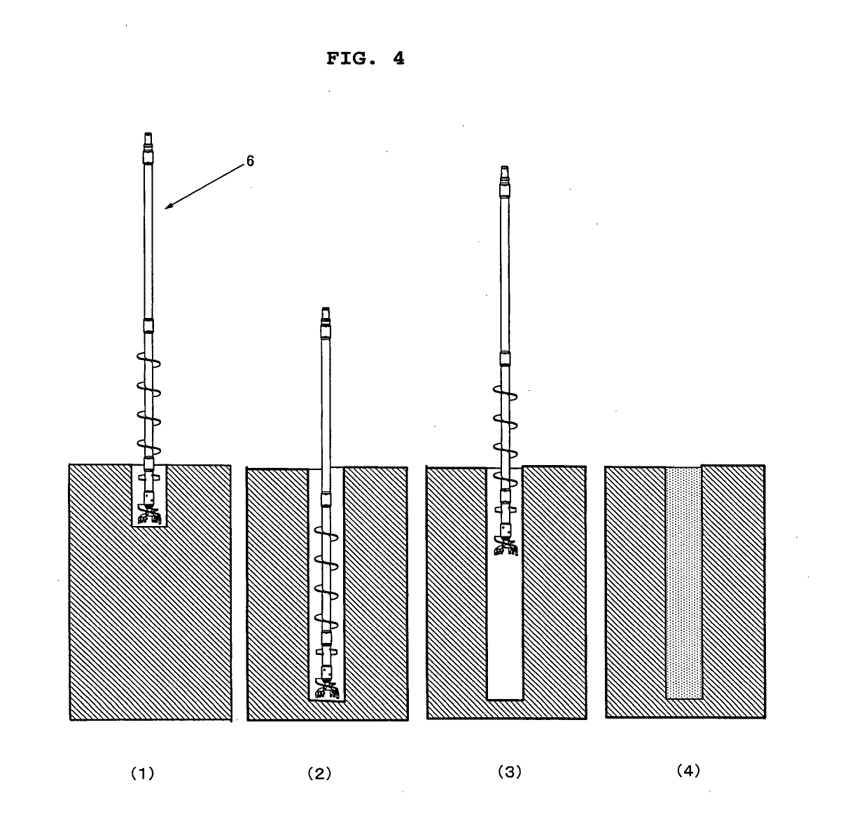

A method for forming an underground impermeable wall according to the present invention employing a single-shaft excavator will be explained based on FIG. 4. A first pattern is based on the above described first to fourth embodiments. First, as shown in FIG. 4(1), as a first step, suspension A1 or suspension B1 is discharged as a slurry from the first discharge outlet (unillustrated) at the lower end of the excavating shaft 6 by the single-shaft excavator 1, the clay mineral suspension is mixed and agitated with earth and sand of the ground by agitation head 6a, and the target ground is excavated by the excavation head 6b while collapse or the like of the excavation pit is prevented.

After the excavation is carried out to a predetermined depth as shown in FIG. 4(2), as shown in FIG. 4(3), as a second step, powder/granule A1 or powder/granule B1 is transported to the conveying conduit (unillustrated) which is formed in the excavating shaft 6 by pneumatic compression by use of a force feeding apparatus such as compressor (unillustrated), and the agitation head 6a is rotated so as to mix and agitate the clay mineral which is in a powdery or granular state with earth and sand of the ground and clay mineral suspension while powder/granule A1 or powder/granule B1 is being discharged from the second discharge outlet (unillustrated) formed in the excavating shaft 6, and simultaneously, the excavating shaft 6 is pulled out.

As a result, an impermeable pile is formed in the target ground as shown in FIG. 4(4). It is not illustrated, but when such impermeable piles are successively formed, a column-row type underground impermeable wall will be formed.

The fluid channel for conveying the clay mineral suspension may also serve as the conveying conduit for conveying the clay mineral which is in a powdery or granular state. However, the conduit is preferably provided separately to avoid contact with water, in order to prevent the increase of viscosity, in the conduit, of the clay mineral which is in a powdery or granular state.

Herein, in the second step, the reason why powder/granule A1 or powder/granule B1 is discharged while the excavating shaft 6 is being pulled out, is to retard increase of viscosity of the clay mineral. That is, with absorption of water, viscosity of clay mineral increases about 30 minutes after the contact with water. Therefore, when mixing and agitating of water, earth and sand, clay mineral suspension, and clay mineral thereof are carried out and the excavating shaft 6 is completely pulled out before the viscosity increases, homogeneous mixing and agitating can be easily carried out while the muddy-water composite earth is kept in low-viscous state, excellent agitation efficiency is exhibited, and after the mixing and agitating, an impermeable wall having a strength equivalent to the ground is formed.

As far as the excavating shaft 6 is completely pulled out within the above described time after the discharge of the clay mineral which is in a powdery or granular state, the clay mineral which is in a powdery or granular state may be discharged in the excavation stage shown in FIG. 4(1) depends on combination of conditions such as excavation speed, excavation depth, and pull-out speed of the excavating shaft.

(Second Pattern)

A second pattern is based on the above described sixth embodiment. The difference with the first pattern resides in that; as a first step, the clay mineral which is in a powdery or granular state (powder/granule A3 and/or powder/granule B3), or the clay mineral (powder/granule A3 and/or powder/granule B3) and the clay mineral suspension (suspension A3 and/or suspension B3), are discharged from the first and/or the second discharge outlet(s) (unillustrated) at the lower end of the excavating shaft 6 by use of the single-shaft excavator 1, earth and sand of the ground is mixed and agitated with the clay mineral, or the clay mineral and the clay mineral suspension by the agitation head 6a, and excavation of the target ground is carried out by the excavation head 6b while collapse or the like of the excavation pit is prevented.

After the excavation is carried out to a predetermined depth as shown in FIG. 4(2), as shown in FIG. 4(3), as a second step, powder/granule A3 or powder/granule B3 is transported to the conveying conduit (unillustrated) which is formed in the excavating shaft 6 by pneumatic compression by use of a force feeding apparatus such as compressor (unillustrated), and the agitation head 6a is rotated so as to mix and agitate the clay mineral which is in a powdery or granular state, earth and sand of the ground, and clay mineral suspension, while powder/granule A3 or powder/granule B3 is being discharged from the second discharge outlet (unillustrated) formed in the excavating shaft 6, and simultaneously, the excavating shaft 6 is pulled out. Being same as the first pattern, the explanation for the rest is omitted.

(Third Pattern)

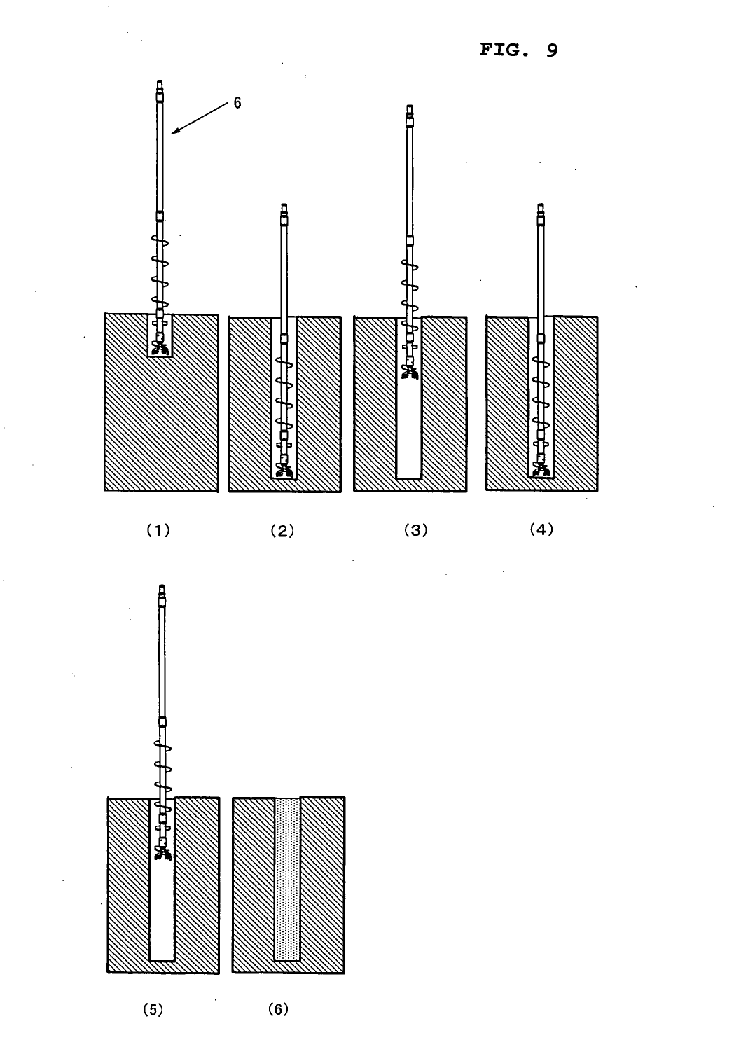

A third pattern is based on the above described seventh embodiment. First, as shown in FIG. 9(1), as a first step, the clay mineral which is in a powdery or granular state (powder/granule A4 and/or powder/granule B4), or the clay mineral (powder/granule A4 and/or powder/granule B4) and the clay mineral suspension (suspension A4 and/or suspension B4), are discharged from the first and/or the second discharge outlet(s) (unillustrated) at the lower end of the excavating shaft 6 by use of the single-shaft excavator 1, earth and sand of the ground is mixed and agitated with the clay mineral, or the clay mineral and the clay mineral suspension by the agitation head 6a, and excavation of the target ground is carried out by the excavation head 6b while collapse or the like of the excavation pit is prevented.

Then, after the excavation is carried out to a predetermined depth as shown in FIG. 9(2), as shown in FIG. 9(3), as a second step, without discharging the clay mineral suspension (suspension A4 and/or suspension B4) and the clay mineral which is in a powdery or granular state (powder/granule A4 and/or powder/granule B4), the agitation head 6a is rotated, earth and sand of the ground, the clay mineral suspension, and the clay mineral which is in a powdery or granular state are mixed and agitated, and simultaneously, the excavation shaft 6 is pulled out.

Then, as shown in FIG. 9(3), as a third step, the excavation shaft 6 is re-inserted to the excavation pit which has been formed in the first step, and simultaneously, the clay mineral which is in a powdery or granular state (powder/granule A4 and/or powder/granule B4) is discharged, and mixing and agitating of the clay mineral with the muddy-water composite earth is thoroughly carried out to the bottom as shown in FIG. 9(4).

Then, as a fourth step, as shown in FIG. 9(5), without discharging the clay mineral suspension (suspension A4 and/or suspension B4) and the clay mineral which is in a powdery or granular state (powder/granule A4 and/or powder/granule B4), the agitation head 6a is rotated, earth and sand of the ground, the clay mineral suspension, and the clay mineral which is in a powdery or granular state are mixed and agitated, and simultaneously, the excavation shaft 6 is pulled out.

<Application of a Tri-Shaft Excavator>

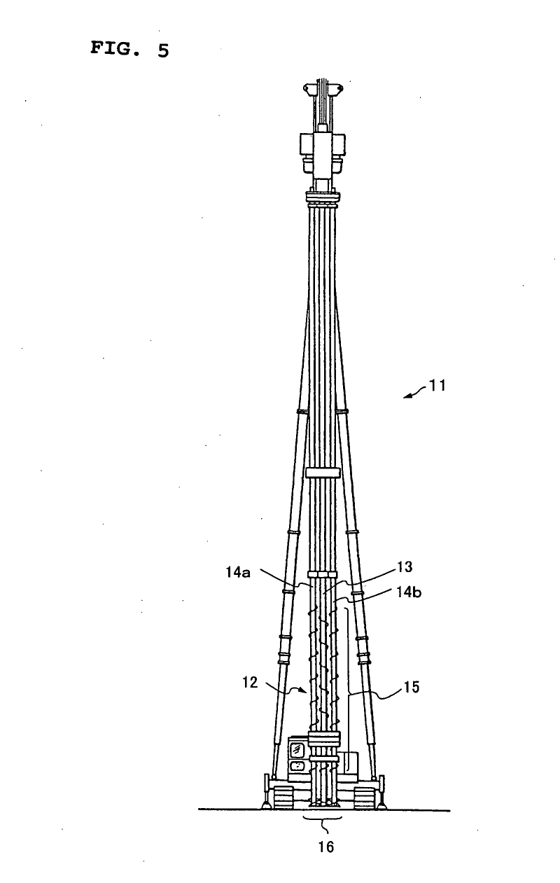

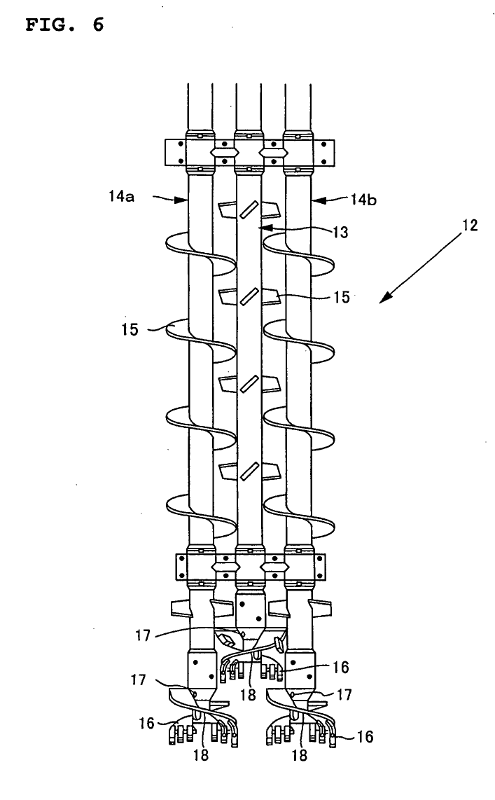

Among multi-shaft excavators, application of a tri-shaft excavator is mainly explained below. A tri-shaft excavator 11 has its entire structure, for example, that shown in FIG. 5. The difference with the single-shaft excavator 1 resides in that, as shown in FIG. 6, the excavating shaft 12 is composed of three excavating shafts, i.e., composed of a center excavating shaft 13 and side-end excavating shafts 14a and 14b provided such that the center excavating shaft 13 is sandwiched between them. Since the structure other than that described here is almost same as the structure of single-shaft excavator 1, only about the structure of the excavating shaft 12 is explained here, and structure explanations for the rest are omitted.

Each of the center excavating shaft 13 and side-end excavating shafts 14a and 14b is composed of a plurality of excavating rod units connected in the longitudinal direction, and includes an agitation head 15 at its lower part and excavation head 16 attached to its lower end. The agitation head 15 is composed of blade portions or spiral blades. Fluid feeding sources (unillustrated) for feeding clay mineral suspension such as suspension A or suspension B are provided at the upper end of the center excavating shaft 13 and side-end excavating shafts 14a and 14b, and fluid channels (unillustrated) for the suspension is formed in the center excavating shaft 13 and side-end excavating shafts 14a and 14b, such that the clay mineral suspension can be discharged from the first discharge outlets 17 formed on the side surface of the center excavating shaft 13 and side-end excavating shafts 14a and 14b at their lower ends. Therefore, in this case, the first outlets 17 are rotated along with the rotation of the center excavating shaft 13 and side-end excavating shafts 14a and 14b, and the clay mineral suspension provided from the fluid feeding source is ejected during the rotation. Obviously, the first discharge outlets 17 are most preferably provided at the lower end in regard to their height level, however, the outlets may be provided upper than that. The fluid channels (unillustrated) that are connected to the first discharge outlets 17 may be disposed outside the shafts instead of being disposed in the center excavating shaft 13 and side-end excavating shafts 14a and 14b like the above described example.

Conveying conduits (unillustrated) are formed in the center excavating shaft 13 and the side-end excavating shafts 14a and 14b. A force feeding apparatus (unillustrated) such as compressor for transporting clay mineral such as powder/granule A or powder/granule B by air compression, is connected to one end of the conveying conduits (unillustrated) at outside. Second discharge outlets 18 for discharging the conveyed clay mineral are formed at the lower end of the center excavating shaft 13 and the side-end excavating shafts 14a and 14b.

A tri-shaft excavator of this kind is publicly known, and a method for forming an underground impermeable wall according to the present invention is not limited to the above described tri-shaft excavator 11.

A method for forming an underground impermeable wall according to the present invention which corresponds to the first pattern of the single-shaft excavator and employs tri-shaft excavator is not illustrated. First, as a first step, suspension A1 or suspension B1 is discharged as a slurry from the first discharge outlets 17 of the side-end excavating shafts 14a and 14b by the tri-shift excavator 11, the clay mineral suspension is mixed and agitated with earth and sand of the ground by agitation head 15, and auxiliary excavation of the target ground is carried out by the excavation head 16 of the side-end excavating shafts 14a and 14b preceding the main excavation by the center excavating shaft 13 while collapse or the like of auxiliary excavation pits are prevented. Then the following center excavating shaft 13 is inserted to the target ground, suspension A1 or suspension B1 is discharged also from the first discharge outlets 17 of the center excavating shaft 13, and main excavation is carried out simultaneously with the auxiliary excavation by the side-end excavating shafts 14a and 14b.

After the excavation is carried out to a predetermined depth, as a second step, powder/granule A1 or powder/granule B1 is transported to the conveying conduits (unillustrated) formed in the center excavating shaft 13 and the side-end excavating shafts 14a and 14b, by pneumatic compression by use of a force feeding apparatus such as compressor (unillustrated), and the agitation head 15 is rotated so as to mix and agitate earth and sand of the ground, clay mineral suspension, and the clay mineral which is in a powdery or granular state while powder/granule A1 or powder/granule B1 is being discharged from the second discharge outlets 18 formed on the center excavating shaft 13 and the side-end excavating shafts 14a and 14b, and simultaneously, the center excavating shaft 13 and the side-end excavating shafts 14a and 14b are pulled out.

As a result, a columnar impermeable pile is formed in the target ground. It is not illustrated, but when such impermeable piles are successively formed, a column-row type underground impermeable wall will be formed.

The fluid channel for conveying the clay mineral suspension may also serve as the conveying conduit for conveying the clay mineral which is in a powdery or granular state. However, the conduit is preferably provided separately to avoid contact with water, in order to prevent the increase of viscosity, in the conduit, of the clay mineral which is in a powdery or granular state.

Herein, in the second step, the reason why powder/granule A1 or powder/granule B1 is discharged while the center excavating shaft 13 and the side-end excavating shafts 14a and 14b are being pulled out, is to retard increase of viscosity of the clay mineral. That is, with absorption of water, viscosity of clay mineral increases about 30 minutes after the contact with water. Therefore, when mixing and agitating of water, earth and sand, clay mineral suspension, and clay mineral thereof are carried out and the center excavating shaft 13 and the side-end excavating shafts 14a and 14b are completely pulled out before the viscosity increases, homogeneous mixing and agitating can be easily carried out while the muddy-water composite earth is kept in low-viscous state, excellent agitation efficiency is exhibited, and after the mixing and agitating, an underground impermeable wall having a strength equivalent to the ground is formed.

Various modifications are conceivable for the discharging manner of the clay mineral suspension and the clay mineral which is in a powdery or granular state by use of the above described tri-shaft excavator 11. For example, the clay mineral suspension may be discharged only from the first discharge outlets 17 of the side-end excavating shafts 14a and 14b in the excavation stage, and the clay mineral which is in a powdery or granular state may be discharged only from the second outlets 18 of the center excavating shaft 13 in the stage of pull-out.

As far as the center excavating shaft 13 and the side-end excavating shafts 14a and 14b are completely pulled out within the above described time after the discharge of the clay mineral which is in a powdery or granular state, the clay mineral which is in a powdery or granular state may be discharged in the excavation stage depends on combination of conditions such as excavation speed, excavation depth, and pull-out speed of the excavating shaft.

A tri-shaft excavator is explained above, however, four-shaft to six-shaft excavators and other excavators having more than six excavating shafts may be applied. The operation methods corresponding to the second pattern and the third pattern of the single-shaft excavator are almost same as those of the second pattern and the third pattern of the single-shaft excavator, therefore the explanations are omitted.

<Application of a Chain Cutter Type Excavator>

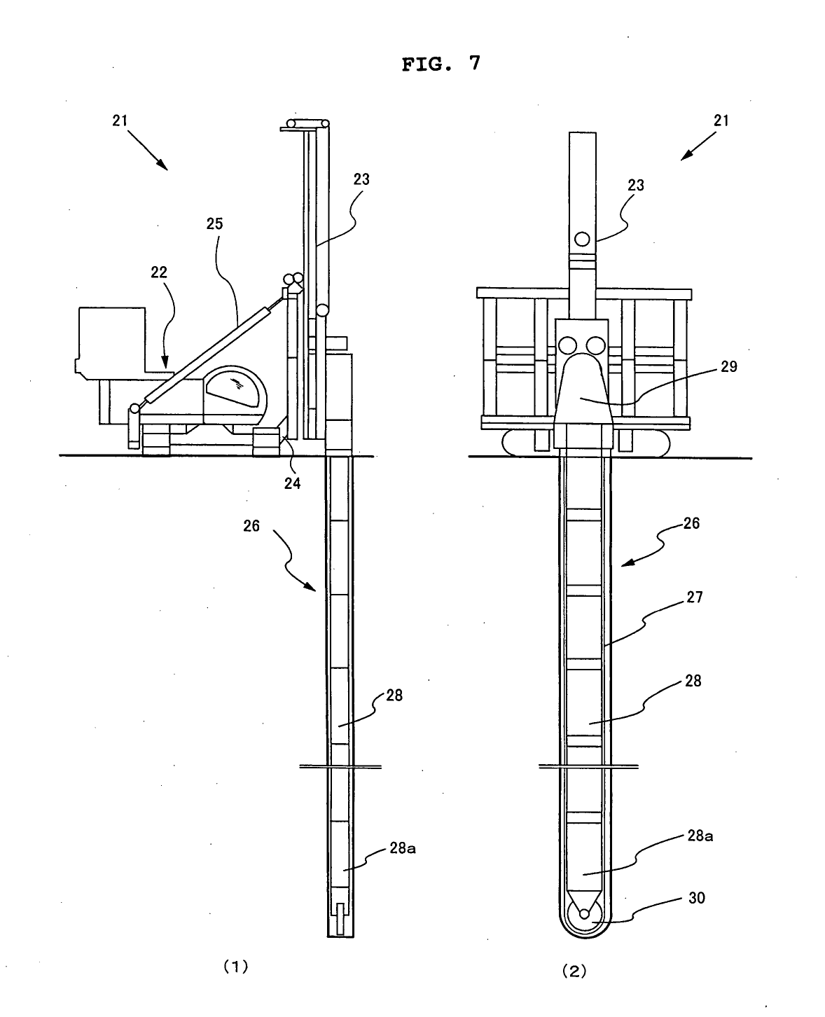

A chain cutter type excavator 21 has its entire structure, for example, that shown in FIG. 7(1) and (2) Herein, FIG. 7(1) is a side view of the chain cutter type excavator 21, and FIG. 7(2) is a front view of the excavator. In the structure, a leader 23 which is upheld and set at the front of a base machine 22 is supported by a leader receptacle 24 and a backstay 25 of the base machine 22. At the leader 23, a guide post 28 which is composed of a plurality of guide post units connected in the longitudinal direction, for guiding an endless chain 27 which is incorporated to a cutter 26 as a part, is provided so as to be movable in the vertical direction, and a motive power source 29 which employs, for example, an electric motor and is slidable along the leader 3, is mounted at the head of the guide post 28. The motive power of the motive power source 29 is transmitted to the endless chain 27, which is described later, via a driving wheel for driving a chain (unillustrated).

A cutter 26 is composed of a guide post 28, a drive wheel for driving the chain (unillustrated), a later-described chain sprocket 30, an endless chain 27, a plurality of cutter bits (unillustrated), and an agitation bar (unillustrated). The drive wheel for driving the chain (unillustrated) is provided at the top of the guide post 28, and the chain sprocket 30 is provided rotatably at a lowest-end guide post 28a. The endless chain 27 is wound over the guide post 28, the drive wheel for driving the chain, and the chain sprocket 30. A plurality of cutter bits (unillustrated) and agitation bar (unillustrated) are alternately disposed on the endless chain 27. The endless chain 27 is rotated by the motive power transmitted from the motive power source 29 via the drive wheel for driving the chain.

A fluid channel (unillustrated) for conveying the clay mineral suspension such as suspension A and suspension B fed from a fluid feeding source (unillustrated) which is provided at outside, is formed in the guide post 28, such that the above described clay mineral suspension can be discharged from the first discharge outlets (unillustrated) at the lower part of the lowest-end guide post 28a.

A conveying conduit (unillustrated) is formed in the guide post 28, a force feeding apparatus such as compressor (unillustrated) for transporting, by pneumatic compression, clay mineral such as powder/granule A or powder/granule B is connected to one end of the conveying conduit (unillustrated), and the second discharge outlets (unillustrated) for discharging the conveyed clay mineral are formed at the lower part of the lowest-end guide post 28a.

A chain cutter type excavator 21 of this kind is publicly known, and a method for forming an underground impermeable wall according to the present invention is not limited to the above described chain cutter type excavator 21. The first and second discharge outlets are preferably formed on the lowest-end guide post 28a, however, the outlets may be formed on arbitrary guide post 28, 28 . . .

(First Pattern)

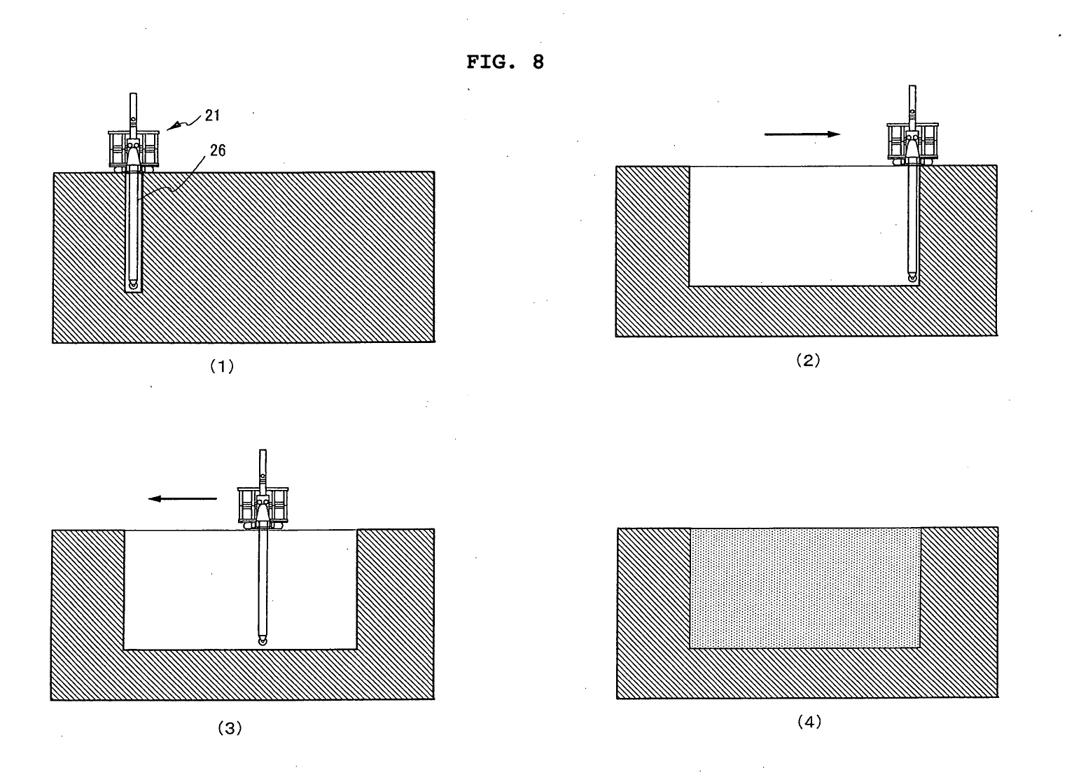

A method for forming an underground impermeable wall according to the present invention employing a chain cutter type excavator is explained below based on FIG. 8. A first pattern is based on the above described first to fourth embodiments. First, the cutter 26 is set in the target ground as shown in FIG.8(1) by inserting the cutter 26 into an excavation pit which has been excavated to a predetermined depth in advance, or setting in to a predetermined depth by itself while guide post units are connected successively. As shown in FIG. 8(2), as a first step, suspension A1 or suspension B1 is discharged as a slurry from the first discharge outlets (unillustrated) at the lower part of the lowest-end guide post 28a while the base machine 22 is moved to the direction of the arrow (approaching route) from the setting-in position of the cutter, and earth and sand of the ground and the clay mineral suspension are mixed and agitated by an agitation bar, and groove excavation of the target ground is carried out by cutter bits while the collapse or the like of the excavation groove is prevented.

After the groove excavation is carried out to a predetermined depth, as shown in FIG. 8(3), as a second step, powder/granule A1 or powder/granule B1 is discharged from the second discharge outlets (unillustrated), and simultaneously, the base machine 22 is moved in the direction of the arrow (returning route) toward the setting-in position of the cutter which serves as a starting point while the agitation bar is rotated and the earth and sand of the ground, the clay mineral suspension, and the clay mineral which is in a powdery or granular state are mixed and agitated, and after returning to the setting-in position of the cutter, the cutter 26 is pulled out.

As a result, a continuous impermeable wall is formed in the target ground at the portion where groove excavation is carried out.

The fluid channel for conveying the clay mineral suspension may also serve as the conveying conduit for conveying the clay mineral which is in a powdery or granular state. However, the conduit is preferably provided separately to avoid contact with water, in order to prevent the increase of viscosity, in the conduit, of the clay mineral which is in a powdery or granular state.

Herein, in the second step, the reason why powder/granule A1 or powder/granule B1 is discharged while the base machine 22 is on the returning move, is to retard increase of viscosity of the clay mineral. That is, with absorption of water, viscosity of clay mineral increases about 30 minutes after the contact with water. Therefore, when mixing and agitating of water, earth and sand, clay mineral suspension, and clay mineral thereof are carried out and the cutter 26 which has finished returning move to return to the setting-in position of the cutter, is completely pulled out before the viscosity increases, homogeneous mixing and agitating can be easily carried out while the muddy-water composite earth is kept in low-viscous state, excellent agitation efficiency is exhibited, and after the mixing and agitating, an underground impermeable wall having a strength equivalent to the ground is formed.

As far as the cutter is completely pulled out within the above described time after the discharge of the clay mineral which is in a powdery or granular state, the clay mineral which is in a powdery or granular state may be discharged in the excavation stage which is shown in FIG. 8(2), depends on combination of conditions such as excavation speed, moving distance and speed of the base machine, and pull-out speed of the cutter.

(Second Pattern)

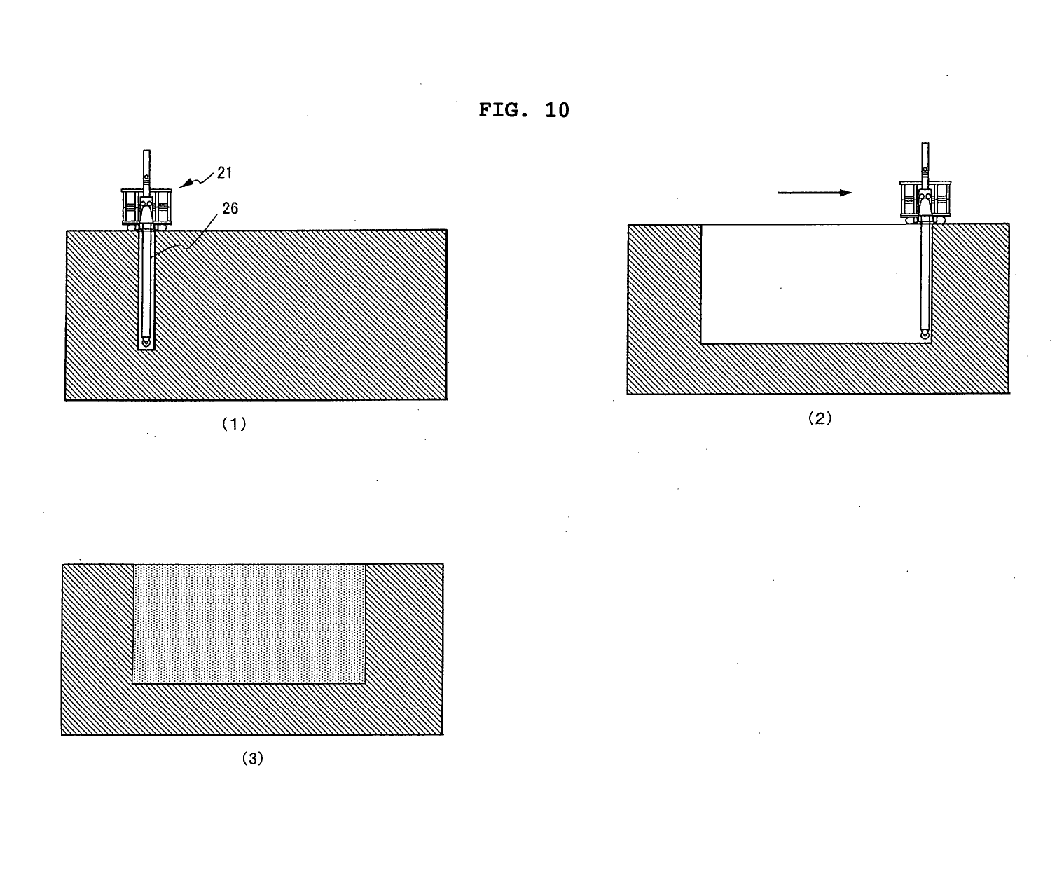

The second pattern is based on the above described fifth embodiment. The difference with the first pattern resides in that, as shown in FIG. 10(1) and (2), the base machine 22 is moved to the direction of the arrow from the setting-in position of the cutter, and simultaneously, the clay mineral which is in a powdery or granular state (powder/granule A2 and/or powder/granule B2), or the clay mineral (powder/granule A2 and/or powder/granule B2) and the clay mineral suspension (suspension A2 and/or suspension B2) are discharged from the first and/or the second discharge outlets (unillustrated) at the lower part of the lowest-end guide post 28a, earth and sand of the ground, the clay mineral suspension, and the clay mineral which is in a powdery or granular state are mixed and agitated by an agitation bar, and the groove excavation of the target ground is carried out by cutter bits while collapse or the like of the excavation groove is prevented. As a result, a continuous underground impermeable wall is formed in the target ground at the portion where groove excavation is carried out.

The fluid channel for conveying the clay mineral suspension may also serve as the conveying conduit for conveying the clay mineral which is in a powdery or granular state. However, the conduit is preferably provided separately to avoid contact with water, in order to prevent the increase of viscosity, in the conduit, of the clay mineral which is in a powdery or granular state. More preferably, at least the clay mineral which is in a powdery or granular state is discharged from the discharge outlets (unillustrated) disposed on the opposite direction in respect to the moving direction of the base machine 22 (the side not facing the ground to be excavated) such that agitation is carried out easier in order to prevent producing agglomerates (grain-like clods produced as a result of poor dissolution). Being almost same as the first pattern, explanations for the rest are omitted.

(Third Pattern)

The third pattern is based on the above described sixth embodiment. The difference with the first pattern resides in that, as a first step, the clay mineral which is in a powdery or granular state (powder/granule A3 and/or powder/granule B3), or the clay mineral (powder/granule A3 and/or powder/granule B3) and the clay mineral suspension (suspension A3 and/or suspension B3) are discharged from the first and/or the second discharge outlets (unillustrated) at the lower part of the lowest-end guide post 28a, earth and sand of the ground, the clay mineral suspension, and the clay mineral which is in a powdery or granular state are mixed and agitated by an agitation bar, and the groove excavation of the target ground is carried out by cutter bits while collapse or the like of the excavation groove is prevented. Being almost same as the first pattern or the second pattern, explanations for the rest are omitted.

(Fourth Pattern)

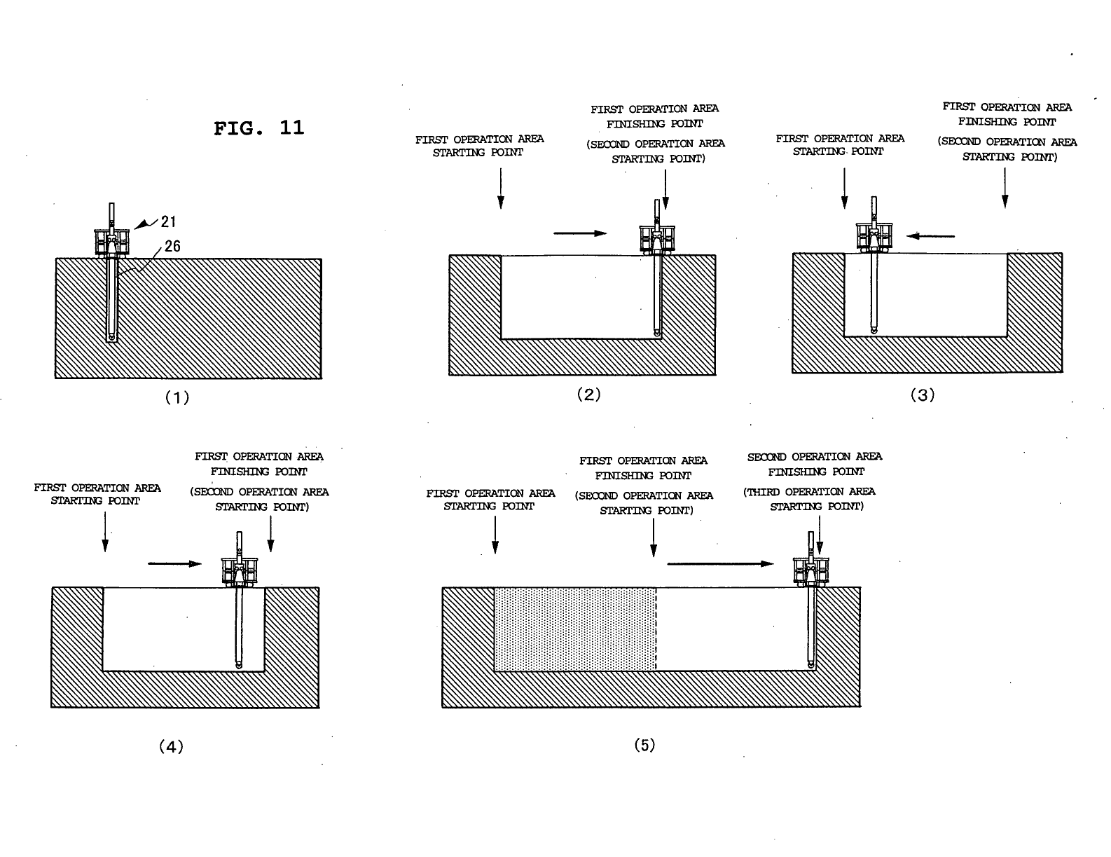

A fourth pattern is based on the above described eighth embodiment. As shown in FIG. 11(1), as a first step, the base machine 22 is moved to the direction of the arrow (approaching route) from the first operation area starting point as shown in FIG. 11(2), wherein the setting-in position of the cutter serves as the operation area starting point, and simultaneously, groove excavation to the first operation area finishing point which is a predetermined length away from the starting point is carried out, the clay mineral which is in a powdery or granular state (powder/granule A5 and/or powder/granule B5), or the clay mineral (powder/granule A5 and/or powder/granule B5) and the clay mineral suspension (suspension A5 and/or suspension B5) are discharged from the first and/or the second discharge outlets (unillustrated) at the lower part of the lowest-end guide post 28a, earth and sand of the ground, the clay mineral suspension, and the clay mineral which is in a powdery or granular state are mixed and agitated by an agitation bar, and groove excavation of the target ground is carried out by cutter bits while the collapse or the like of the excavation groove is prevented.

As a second step, as shown in FIG. 11(3), only further mixing and agitating of the muddy-water composite earth produced by the mixing and agitating in the first step is carried out without discharging the clay mineral suspension and the clay mineral which is in a powdery or granular state, while the base machine 22 returns to the first operation area starting point from the first operation area finishing point.

As a third step, the base machine moves again to the first operation area finishing point after returning to the first operation area starting point as shown in FIG. 11(4), and simultaneously, the clay mineral which is in a powdery or granular state (powder/granule A5 and/or powder/granule B5) is discharged between the first operation area starting point and the first operation area finishing point, the clay mineral and the muddy-water composite earth are mixed and agitated, the clay mineral which is in a powdery or granular state (powder/granule A5 and/or powder/granule B5), or the clay mineral (powder/granule A5 and/or powder granule B5) and the clay mineral suspension (suspension A5 and/or suspension B5) are discharged from the first or the second discharge outlets (unillustrated) at the lower part of the lowest-end guide post 28a while groove excavation is carried out from the second operation area starting point, which is the first operation area finishing point, to the second operation area finishing point which is a predetermined length away from the starting point as shown in FIG. 11(5), earth and sand of the ground, the clay mineral suspension, and the clay mineral which is in a powdery or granular state are mixed and agitated by an agitation bar, and groove excavation of the target ground is carried out by cutter bits while the collapse or the like of the excavation groove is prevented.

It is not illustrated, but forming of an underground impermeable wall is carried out in all the operation area by repeating the above described second step and the third step in turn, wherein a preceding operation area finishing point serves as a following operation area starting point. Being almost same as the first to the third pattern, explanations for the rest are omitted.

1. A method for forming an underground impermeable wall comprising:
a first step of discharging a clay-mineral suspension and mixing and agitating said clay-mineral suspension with earth and sand of the above described ground, during excavation of the target ground; and
a second step of transporting by pneumatic compression a clay mineral which is in a powdery or granular state to muddy-water composite earth obtained by mixing and agitating in the first step, and simultaneously mixing and agitating said clay mineral which is in a powdery or granular state with the muddy-water composite earth.

2. A method for forming an underground impermeable wall as described in claim 1, wherein the amount of the clay mineral in the clay-mineral suspension in the first step is 30 to 500 kg per 1 m³ of water, and the amount of the clay mineral which is in a powdery or granular state in the second step is 20 to 450 kg per 1 m³ of the earth and sand to be mixed with.

3. A method for forming an underground impermeable wall as described in claim 1 or 2, wherein an excavator equipped with a single or a plurality of excavating shaft(s) is employed, the first step is carried out while excavation is being carried out by said excavating shaft(s), and the second step is carried out while the excavating shaft(s) is being pulled out.

4. A method for forming an underground impermeable wall as described in claim 1 or 2, wherein a chain cutter type excavator which is equipped with a movable base machine and a cutter for groove excavation of the target ground is employed, the first step is carried out while said chain cutter type excavator moves in one direction starting from the setting-in position of the cutter and groove excavation is simultaneously carried out, and the second step is carried out while the chain cutter type excavator returns to the setting-in position of the cutter.

5. A method for forming an underground impermeable wall comprising:
discharging a clay mineral which is in a powdery or granular state, or said clay mineral and a clay mineral suspension, and mixing and agitating the clay mineral, or said clay mineral and the clay mineral suspension with earth and sand of the above described ground, during excavation of the target ground.

6. A method for forming an underground impermeable wall as described in claim 5, wherein the amount of the clay mineral which is in a powdery or granular state is 20 to 450 kg per 1 m³ of the earth and sand to be mixed with, and the amount of the clay mineral in the clay-mineral suspension is 30 to 500 kg per 1 m³ of water.

7. A method for forming an underground impermeable wall as described in claim 5 or 6, wherein a chain cutter type excavator which is equipped with a movable base machine and a cutter for groove excavation of the target ground is employed, and said chain cutter type excavator moves in one direction starting from the setting-in position of the cutter and groove excavation is simultaneously carried out.

8. A method for forming an underground impermeable wall comprising:
a first step of discharging a clay mineral which is in a powdery or granular state, or said clay mineral and a clay mineral suspension, and mixing and agitating the clay mineral, or said clay mineral and the clay mineral suspension with earth and sand of the above described ground, during excavation of the target ground; and
a second step of discharging a clay mineral which is in a powdery or granular state to muddy-water composite earth obtained by mixing and agitating in the first step, and mixing and agitating the clay mineral with the muddy-water composite earth.

9. A method for forming an underground impermeable wall as described in claim 8, wherein,
in the first step, the amount of the clay mineral which is in a powdery or granular state is 20 to 450 kg per 1 m³ of the earth and sand to be mixed with, and the amount of the clay mineral in the clay-mineral suspension is 30 to 500 kg per 1 m³ of water; and
the amount of the clay mineral which is in a powdery or granular state in the second step is 20 to 450 kg per 1 m³ of the earth and sand to be mixed with.

10. A method for forming an underground impermeable wall as described in claim 8 or 9, wherein
an excavator equipped with a single or a plurality of excavating shaft(s) is employed, and
the first step is carried out while excavation is being carried out by the excavating shaft(s), and the second step is carried out while the excavating shaft(s) is being pulled out.

11. A method for forming an underground impermeable wall as described in claim 8 or 9, which employs a chain cutter type excavator equipped with a movable base machine and a cutter for groove excavation of the target ground, wherein
the first step is carried out while said chain cutter type excavator moves in one direction from a starting point which is the setting-in position of the cutter and groove excavation is simultaneously carried out; and
the second step is carried out while the chain cutter type excavator returns to the setting-in position of the cutter.

12. A method for forming an underground impermeable wall which employs an excavator equipped with a single or a plurality of excavating shaft(s), the method comprising:
a first step of discharging a clay mineral which is in a powdery or granular state, or said clay mineral and a clay mineral suspension, and mixing and agitating the clay mineral, or said clay mineral and the clay mineral suspension with earth and sand of the above described ground, while excavation is carried out to a predetermined depth by the excavating shaft(s);
a second step of carrying out only further mixing and agitating of muddy-water composite earth obtained by mixing and agitating in the first step, while the excavating shaft(s) is being pulled out without discharging the clay mineral suspension and the clay mineral which is in a powdery or granular state;
a third step of re-inserting the excavating shaft(s) into the excavation pit which is formed in the first step, and simultaneously discharging the clay mineral which is in a powdery or granular state and mixing and agitating the clay mineral with the muddy-water composite earth; and
a fourth step of carrying out only mixing and agitating while the excavating shaft(s) is being pulled out without discharging the clay mineral suspension and the clay mineral which is in a powdery or granular state.

13. A method for forming an underground impermeable wall as described in claim 12, wherein,
in the first step, the amount of the clay mineral which is in a powdery or granular state is 20 to 450 kg per 1 m³ of the earth and sand to be mixed with, and the amount of the clay mineral in the clay-mineral suspension is 30 to 500 kg per 1 m³ of water; and
the amount of the clay mineral which is in a powdery or granular state in the third step is 20 to 450 kg per 1 m³ of the earth and sand to be mixed with.

14. A method for forming an underground impermeable wall which employs a chain cutter type excavator equipped with a movable base machine and a cutter for groove excavation of the target ground, the method comprising:
a first step of discharging a clay mineral which is in a powdery or granular state, or said clay mineral and a clay mineral suspension, and mixing and agitating the clay mineral, or said clay mineral and the clay mineral suspension with earth and sand of the above described ground, while said chain cutter type excavator moves a predetermined length in one direction from a first operation area starting point which is the setting-in position of the cutter to a first operation area finishing point and groove excavation is carried out;
a second step of carrying out only further mixing and agitating of muddy-water composite earth obtained by mixing and agitating in the first step, without discharging the clay mineral suspension and the clay mineral which is in a powdery or granular state, while the chain cutter type excavator returns to the first operation area starting point from the first operation area finishing point;
a third step of discharging the clay mineral which is in a powdery or granular state, and mixing and agitating the clay mineral with the muddy-water composite earth while the excavator moves again to the first operation area finishing point after the excavator returns to the first operation area starting point, until the excavator reaches the first operation area finishing point, and
discharging the clay mineral which is in a powdery or granular state, or said clay mineral and a clay mineral suspension, and mixing and agitating the clay mineral, or said clay mineral and the clay mineral suspension with the earth and sand of the above described ground, while the excavator carries out a predetermined length of groove excavation from a second operation area starting point which is the first operation area finishing point to a second operation area finishing point; and
repeating the second step and third step in turn for forming an underground impermeable wall in the all operation area, wherein a finishing point of a preceding operation area serves as a starting point of a following operation area.

15. A method for forming an underground impermeable wall as described in claim 14, wherein,
in the first step, the amount of the clay mineral which is in a powdery or granular state is 20 to 450 kg per 1 m³ of the earth and sand to be mixed with, and the amount of the clay mineral in the clay-mineral suspension is 30 to 500 kg per 1 m³ of water;
in the third step, between the first operation area starting point to the first operation area finishing point, the amount of the clay mineral which is in a powdery or granular state is 20 to 450 kg per 1 m³ of the earth and sand to be mixed with; and
in the third step, between the second operation area starting point to the second operation area finishing point which is disposed a predetermined length away from the second area operation starting point, the amount of the clay mineral which is in a powdery or granular state is 20 to 450 kg per 1 m³ of the earth and sand to be mixed with, and the amount of the clay mineral in the clay mineral suspension is 30 to 500 kg per 1 m³ of water.
